(19) United States
(12) Patent Application Publication
(10) Pub. No.: US 2006/0015383 A1
(43) Pub. Date: Jan. 19, 2006

(54) Generic contextual floor plans

(76) Inventors: Joerg Beringer, Frankfurt (DE); Michael Hatscher, Hamburg (DE); Sandra Nieves, Karlsruhe (DE); Eric Wood, Menlo Oaks, CA (US); Dennis Moore, Burlingame, CA (US)

Correspondence Address: KENNETH F. KOZIK, ESQ.;HOLLAND & KNIGHT LLP, 10 ST. JAMES AVENUE, BOSTON, MA, 02116, US

(21) Appl. No.: 11/185,037

(22) Filed: Jul. 19, 2005

(30) Foreign Application Priority Data
Jul. 19, 2004 (EP) EP 04016964.1

(51) Int. Cl. G06F 9/44

(52) U.S. Cl. 705/7

(57) ABSTRACT

Methods and apparatus, including computer program products, for generic contextual floor plans. A computer-implemented method for providing a user interface for running business processes, wherein process data are handled in data objects by one or more service-oriented business applications, including enabling a generalized information architecture for presenting modeled-business situations, including work-roles, process instances, and business object instances for handing the data objects active in the plurality of business processes, enabling an interface generator for directly generating a user interface from the generalized information architecture, and enabling the user interface by the interface generator while identifying a particular instantiated business situation as a business context in the generalized information architecture to which the user interface provides the interface.

### CROSS REFERENCE TO RELATED APPLICATIONS

This application claims the benefit from EP 04016964.1, filed on Jul. 19, 2004, the entire contents of which is incorporated herein by reference.

### BACKGROUND

The present invention relates to data processing by digital computer, and more particularly to generic contextual floor plans.

Applications running business processes are diverse in layout, i.e., a user is confronted with a variety of different design philosophies that makes every day's work very hard since the user usually has to constantly switch from business application to business application, and from a corresponding application interface to another application interface, while performing a particular role in a work process. Diverse layouts prevent consistent overall views and actions to be undertaken in business situations that are present at real time instances.

It is desirable to provide a well structured user interface that enables coherent screens that reflect a work practice of the user in order to provide a good user experience. It is also desirable to structure applications in units of contexts that reflect some meaningful segment of work, typically a role responsibility or an instance of work.

### SUMMARY

The present invention provides methods and apparatus, including computer program products, for generic contextual floor plans.

In general, in one aspect, the invention features a computer-implemented method for providing a user interface for running business processes, wherein process data can be handled in data objects by one or more service-oriented business applications, the computer-implemented method including enabling a generalized information architecture for presenting modeled-business situations, including work-roles, process instances, and business object instances for handing the data objects active in the plurality of business processes, enabling an interface generator for directly generating a user interface from the generalized information architecture, and enabling the user interface by the interface generator while identifying a particular instantiated business situation as a business context in the generalized information architecture to which the user interface provides the interface.

In embodiments, the business context can be displayed by the interface in a view mode and/or an action mode, the modes enabling a specific view on the business context or a specific action in the business context, the interface enabling navigation between different business contexts. The view mode can regard an object-centric view mode and/or a process-centric view mode. The action mode can enable an activity-centric view of context specific activities and/or ad hoc activities to be performed in the context. The activity-centric view can provide a simple activity or a composite activity. The composite activity can be a guided action in which a sequence of screens can be activated each for performing a part of the complex activity.

In embodiments, the interface can be generated from the information architecture using meta data that model the business context.

The invention can be implemented to realize one or more of the following advantages.

A consistent interface is provided that directly reflects the business context a user is interested in by enabling a generalized information architecture for presenting modeled business situations, including work-roles, process instances, and business object instances for handing data objects active in business processes.

The method provides an interface generator for directly generating a user interface from the generalized information architecture and provides the user interface by the interface generator while identifying a particular instantiated business situation as a business context to which the user interface provides the interface.

Specific aspects of a business situation can be presented within a single context. This interface is also referred to as showing “floor plans” or “contextual floor plans” of particular business situations and offers a view mode and/or an action mode, providing a specific view on the business context or a specific action to be performed in the business context. The interface can provide navigation between different business contexts.

The floor plans can include a left-hand contextual panel that supports the within-navigation, and a right hand service container that is used to launch views and actions in-place. This page layout, together with standardized information architecture for the contextual panel, can be applied to different archetypes of business context, such as roles, process instances, object instance views, ad-hoc activity spaces, and event resolution centers.

The contextual panel can include standardized components for switching views on a context, for contextual search, and for launching in-place actions. An instance identifier component and a mini-dashboard inform the user about the identity and status of the currently selected work instance, e.g., the name of a business object or process instance.

The contextual floor plans are used to generate user experience based on meta data that model a business context instead of “hard wiring” them into a page layout description. Contextual floor plans represent major building blocks of application design with a high potential of re-use; they harmonize a user experience across and within applications.

One implementation of the invention provides all of the above advantages.

Other features and advantages of the invention are apparent from the following description, and from the claims.

### BRIEF DESCRIPTION OF THE DRAWINGS

FIG. 1 is a block diagram of a user interface layout for illustrating a contextual floor plan;

FIG. 2 is a block diagram of a specific contextual floor plan illustrating an object centric view;

FIG. 3 is a block diagram of a specific contextual floor plan illustrating a process centric view;

FIG. 4 is a block diagram of a specific contextual floor plan illustrating an activity centric view; and

FIG. 5 is a block diagram of contextual panels for use in a contextual floor plan.

Like reference numbers and designations in the various drawings indicate like

### DETAILED DESCRIPTION

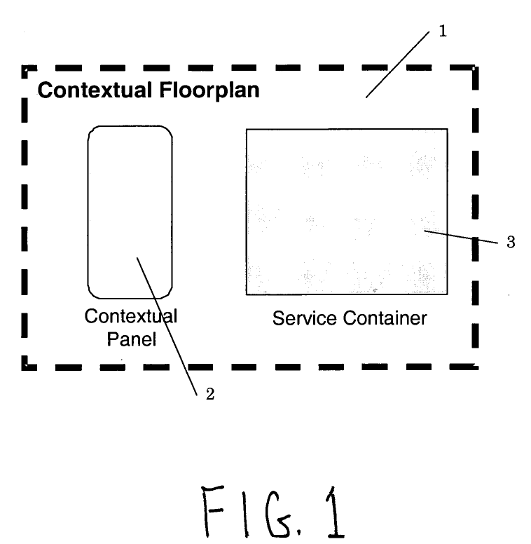

Referring to FIG. 1, for simplifying the task of laying out a number of complex business applications into coherent focus areas, a context-based application design concept is enabled by offering pre-defined contextual floor plans for most common types of work context. A Contextual Floor plan 1 includes of a left hand Contextual Panel 2 that provides consistent navigation and access to contextual actions and views, and a right hand container or content area 3 for launching such views and actions in-place.

The floor plan 1 provides a consistent interaction paradigm for many fundamental context types that are typically found in a business application. In particular, the right hand container 3 is arranged to provide a user interface (UI) to a number of context archetypes that reflect the most common work contexts. Some of them are activity oriented and others are work instance oriented. In particular, these archetypes can be categorized as follows:

Activity-centric contexts. This context is driven by a role, topic, task, or event that triggered this activity. Depending on the specific type, certain actions and resources are meaningful to this context and can be pre-configured as a context template. Activity-centric contexts usually have typical views like work lists, work status dashboards, resources, participants, and so forth.

Object-centric contexts. This context is determined by an object instance and includes related object operations as well as views on all facets on the object. Different job roles may be interested in different facets of the same object type.

Process-centric contexts. This context is a workflow instance. Most actions are executed as predefined process steps. Because of the nature of workflow, selected steps may be owned by different users.

In work instance oriented contexts, a number of views or perspectives is presented, showing various aspects of a particular business situation, in particular, a particular object instance related to the situation or a particular process instance related to the situation.

Important characteristics of a view are the following:

Views are not transactional. They do not need any “close”, “cancel”, or “done” buttons. However, they may include functions within their UI that launch transactional actions.

Views always stay within the same context. The user experience is not navigation, but rather, changing the perspective.

Within a single context, a user can switch to different views for different purposes of assessing the context as is fully described below.

In contrast, in activity-oriented work contexts, a user role is central of a specific user who has to perform certain activities in a certain work context. In addition, certain activities, while not directly related to a specific role in the organization, can be centralized around a specific business situation that arises, such as exception handling or other incidental tasks that may have to be performed in a business. Rather than being assigned to certain job roles of users in a business and the bundle of tasks related to the job roles, these contexts can model an ad-hoc activity space that is focused on a specific business problem or a specific task.

In browsing such a context, the Context Panel 2 lists actions that are relevant for the current work context. In contrast to views, actions are transactional and may even point to another related work context. Whenever possible, actions should be launched “in-place” in the right hand container as described below.

For example, a product manager may work in the context of one particular product or one particular product concept. Inspecting one particular product can be considered as an object-centric work focus. However, the development of a new product concept is driven by a well defined process that models best practices and has stages and gates. The dominant focus in this case is on the process. In addition, the product manager is responsible for monitoring sales performance and is therefore from time to time doing market analysis. This is a work context that is driven by a role responsibility and is not focusing on a particular object or process instance. It is, therefore, a general activity centric context.

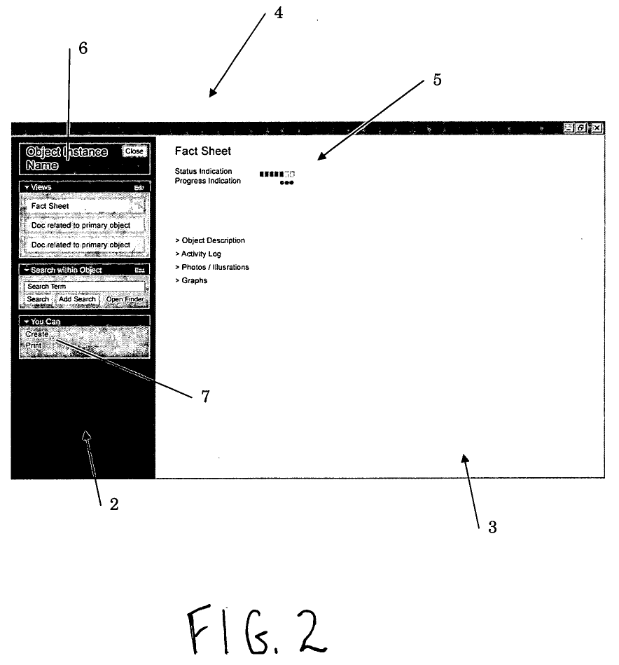

In FIG. 2 an Object Instance View 4 is shown that provides a view on one specific object instance. In this view, different facets of the business object are presented. In addition, possible actions that are listed are actions related to this object.

The Object Instance View 4, as a contextual view, can be activated from either an overview screen (not shown) presenting various selectable context views or through an object lookup action wherein certain object characteristics are input for looking up the object. In an Object Instance View, the focus lies on a concrete instance, the user operates on one particular instance of a business object.

In the object-centered mode—the Object Instance View, the user may choose between different views (perspectives) on a concrete instance of a business object including a “fact sheet”-like overview 5 and detailed views of different facets of the object. All functionality to manipulate and act on the object is provided.

According to the contextual views user interface layout, the Object Action Pattern's layout features a Contextual Panel 2 (CP) with an area for the instance identifier 6, global instance-related and action-related contextual (secondary) actions 7, as well as a content area 3, which displays the object's facets, or actions as chosen from the Contextual Panel or from within a preceding action screen.

In particular, in FIG. 2 a Fact Sheet View of an Object Action Pattern is shown. In the Object Instance View, different perspectives on the object can be presented:

A Class Name view displays the master data of this object type. If required those data may be grouped into several tabs.

A Summary view displays a snapshot of this object with the most essential data. This is analogous to a fact sheet or the overview page. It should inform the user about the basic facts and state of the object.

A Status view provides status indicators as well analytics about this object.

A Facet view provides specific perspectives on the object that represent a type of sub-activity. When users switch to a facet they also focus on managing a specific sub-aspect of the object.

Which of these views are appropriate to include into the object instance view depends on the characteristics of the particular object type. In addition to the fact sheet view, a Main Data view provides access to the main data of an object. If the amount of data does not fit on one screen, those data can be grouped by topic or any other intuitive category and displayed on tabs. While the Fact Sheet is for quick inspection and not for editing, this view is a read and write view to maintain the main data of the object instance—typically the master data.

Object-specific perspective views can be presented as “Facet views”. For complex objects, such additional views may be implemented, each representing a facet of the object. For example, foreign key relationships to other objects are candidates to let users manage such related data within a separate view. For example, all orders related to a supplier, or all attachments related to a product concept would be candidates for facets.

Such additional views are justified if the views represent a primary facet of the object with related actions. In other words, the facet becomes a sub-activity area for one particular aspect of the object. A facet of an object-centric view could be other documents related to the primary object. These other documents are shown in the content area, when clicking on the corresponding view.

In addition, occasional tasks should be implemented as “You Can” actions.

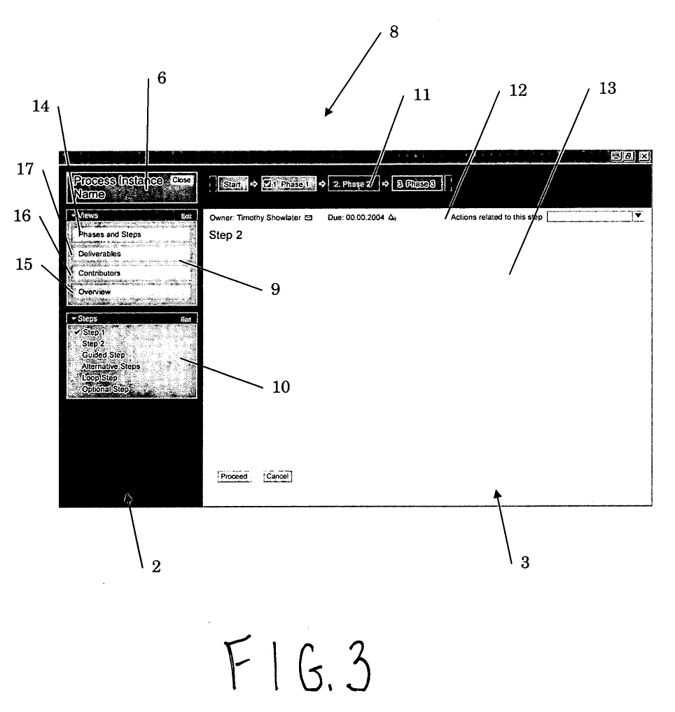

Referring to FIG. 3, a Process Instance view 8 enables an overview on the process in form of phases and steps, and several status views on the process instance. In this view a series of predetermined process steps (also referred to as Guided Procedures) are used for managing collaborative procedures that are defined in form of workflow model and context information.

In particular, in this view, the contextual panel 2 contains an Instance Identifier 6, a Views Area 9, and a Guided Procedure Step Tree 10. The content area 3 features top to bottom the following elements: the Phase Indicator 11 and the Status Bar 12 as well as the area 13 containing the action, which takes up most of the screen real estate.

In this Guided Procedures view different perspectives are presented on the process or its objects:

The “Phases and Steps” process view 14 shows each step for the current phase; when selected, the corresponding action is shown in the content area. This view supports the user in working through the steps of the process.

The Overview 15 shows all phases with all their steps, the current status, and the owner of the step on one page. The overview gives at-a-glance information about the status of the procedure and its objects.

The Contributors 16 view shows all contributors involved in the procedure, which parts of the process they are involved in, and what their contributions are. Collaboration features in this view allow users to get in touch quickly with other contributors, push information to them, or replace them with someone else if need be.

The Deliverables 17 view lists all output of each step that has been completed so far. This view is particularly beneficial for processes that orient themselves around deliverables tracking rather than a timeline or sequence of steps to complete.

Additionally, a Timeline view (not shown) may show the procedure along a timeline, making due dates and time frames more prominent. This view is particularly beneficial when milestones and deadlines are the focus.

Besides the standard overview of “Phase and Steps” 14 that is guiding the user though the process, additional standard views can be provided for tracking the progress, for collaborating among all contributors, and for managing the proves by deliverables.

For example, the Deliverables view 17 provides functions to track and manage deliverables that are associated with a process instance. The view lists the status, and the responsible user. The view also supports related tasks like task assignment and document check in and versioning control.

In addition, the Contributors view 16 opens a list of all the people participating in a given process instance. It offers related ad-hoc collaboration tools to coordinate and communicate with all participants. A process owner can assign tasks to selected users as well as add and remove contributors and assess a single person's contribution to the overall process.

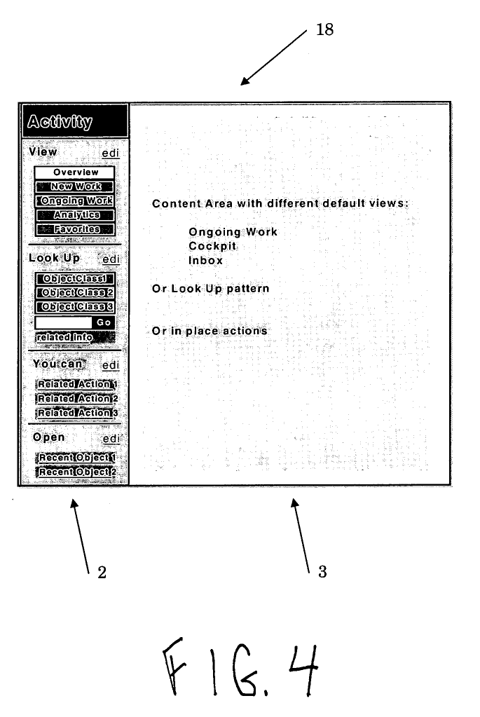

FIG. 4 illustrates an example of a contextual view with an activity centric context, wherein the screen is illustrated as a template having generic controls. When instantiated, these controls are “filled” with relevant data from an activity context. These views are referenced as Work Centers since these are activity-centric places that provide all services necessary to accomplish a set of coherent actions belonging to one of the user's roles. Like switching rooms in a house, each Work Center 18 serves a different role by providing all relevant views for tracking, analyzing, and monitoring work.

The left-hand pane of the Work Center 18 is as each contextual view provided by a Contextual Panel 2 and contains standard tools and functions for controlling the interface and accessing work objects. In addition, the right pane 3 provides a place to do the action selected on the left.

Like Work Centers, ad-hoc Activity Centers are activity-centric places that bundle functions required to accomplish a business goal. But in contrast to Work Centers, it does not reflect a bundle of tasks related to job roles, but rather models an ad-hoc activity space that is focused on a specific business problem or a specific task. Activity Centers are instances of complex tasks that require a persistent activity space to accomplish the task.

Examples of ad-hoc Activity Centers are problem resolutions spaces that require some long running processes for diagnostic purposes and that resolution strategies that are not just a one click actions but a process in its own. For example, let's assume that a person is monitoring invalid invoices and receives an exception notification in his or her inbox. When opening the notification message, an ad-hoc Activity Center is launched that offers within its Contextual Panel 2 various options to inspect and resolve the problem.

From the interaction design point of view, Work Centers and Activity Centers are almost identical except that Activity Centers include options and actions that may close the entire Activity Center or change the status of it.

Depending on the complexity of a task, exception, or work item, it may or may not be appropriate to model the resolution as an Activity Center. It may also be adequate to design a quick action that just lets the user choose between a limited set of option or asks the user to enter new data in order to solve a problem. For example, a simple approval request only requires a simple one-screen interactive message and not a complex activity center.

In the context of activities whether ad-hoc or relating to a work center, most views are providing work support like

Work Trigger Management: Parsing business related work items, exceptions, requests, tasks and react to them in an appropriate way

Status Tracking: Monitoring important business activities, pending ad-hoc processes, tasks in work by means of textual or graphical status displays.

Time Management: Getting a consolidated overview about any time-related business event in order to schedule and plan activities.

Activity Management: Accessing and overseeing standard work contexts (Work Centers deployed as work sets) and personal work contexts (ad-hoc Activity Centers instantiated by users)

Service Gallery: Accessing self-services, procedures, or reports from a single place.

As described above, single actions are launched in-place wherever possible. The idea is that once users launched a new work context, they continue to work within this context without leaving this context. This user experience is achieved by keeping the Contextual Panel 2 constant and launching the activities in-place in the right hand service container. Within the contextual navigation concept, such actions should run in-place next to the Contextual Panel 2 as long as they are not sovereign applications that need full screen real-estate. The idea is that actions can be re-used as task building blocks in any context.

The action framework handles the actual interaction with a single service or software application. Its design depends very much on the specific content of the application, but the action framework standardizes the basic appearance and details of actions.

A number of action categories are discerned:

A simple action. This is a one-screen service that is focused on one work intent. It features standard title elements that describes this action's intent in form of a verb-noun phrase. The action's intent should be explained in a one sentence phrase below the title.

A guided action. The “Guided Action” action floor plan is a framework for navigating through a sequence of screens. Guided Actions either sequentialize user interface interaction into smaller chunks, or concatenate several stand-alone actions into a composite action.

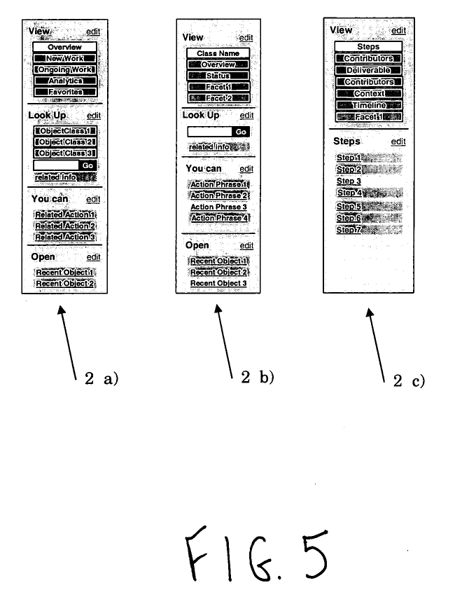

Referring to FIG. 5, a number of appearances are illustrated for the Contextual Panel. These panels have a consistent structure, with defined elements that repeat across the different context types. But depending on the context archetype, the information architecture of the Contextual Panel 2 is slightly different. In particular, (a) shows a contextual panel for an activity Center, (b) shows a contextual panel for an Object Instance View and (c) shows a contextual panel for a Process Instance View.

In all cases, the Contextual Panel provides view switches to select different facets of the current work context. They are a toolset to divide complex function into several intuitive chunks. The switches navigate between different views of the same context. Each view, when activated, may replace subordinate content in the Context Panel, the related actions for example.

Although the same generic control and layout is used, the exact semantics vary depending on the type of work context.

As described with reference to FIG. 4 in conjunction with (a) in FIG. 5, the activity-centric views represent generic perspectives on work and are focused on one particular work role of a user using the user interface. They also may represent secondary activity centers that require their own set of actions.

As described with reference to FIG. 2 in conjunction with (b) in FIG. 5, Object-centric Views provide different views on a given object. They entirely depend on the type of object and reflect natural perspectives on that object. Each perspective may come with its own set of actions and by that represents a little activity center with focus on one concrete object instance.

As described with reference to FIG. 3 in conjunction with (c) in FIG. 5, Process Instance Views provide are generic process tracking and execution views provided by the Guided Procedure framework. Those views can be extended by tailored views depending on the semantics of the procedure.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

It is to be understood that the foregoing description is intended to illustrate and not to limit the scope of the invention, which is defined by the scope of the appended claims. Other embodiments are within the scope of the following claims.

What is claimed is:

1. A computer-implemented method for providing a user interface for running business processes, wherein process data are handled in data objects by one or more service-oriented business applications, the computer-implemented method comprising:
enabling a generalized information architecture for presenting modeled-business situations, including work-roles, process instances, and business object instances for handing the data objects active in the plurality of business processes;
enabling an interface generator for directly generating a user interface from the generalized information architecture; and
enabling the user interface by the interface generator while identifying a particular instantiated business situation as a business context in the generalized information architecture to which the user interface provides the interface.

2. The computer-implemented method according of claim 1 wherein the business context is displayed by the interface in a view mode and/or an action mode, the modes enabling a specific view on the business context or a specific action in the business context, the interface enabling navigation between different business contexts.

3. The computer-implemented method of claim 2 wherein the view mode regards an object centric view mode and/or a process centric view mode.

4. The computer-implemented method of claim 2 wherein the action mode enables an activity centric view of context specific activities and/or ad hoc activities to be performed in the context.

5. The computer-implemented method of claim 4 wherein the activity centric view provides a simple activity or a composite activity.

6. The computer-implemented method of claim 5 wherein the composite activity is a guided action in which a sequence of screens is activated each for performing a part of the complex activity.

7. The computer-implemented method of claim 1 wherein the interface is generated from the information architecture using meta data that model the business context.

8. A computer program product, tangibly embodied in an information carrier, for providing a user interface for running business processes, wherein process data are handled in data objects by one or more service-oriented business applications, the computer program product being operable to cause data processing apparatus to:
enable a generalized information architecture for presenting modeled-business situations, including work-roles, process instances, and business object instances for handing the data objects active in the plurality of business processes;
enable an interface generator for directly generating a user interface from the generalized information architecture; and
enable the user interface by the interface generator while identifying a particular instantiated business situation as a business context in the generalized information architecture to which the user interface provides the interface.

9. The computer program product of claim 8 wherein the business context is displayed by the interface in a view mode and/or an action mode, the modes enabling a specific view on the business context or a specific action in the business context, the interface enabling navigation between different business contexts.

10. The computer program product of claim 9 wherein the view mode regards an object centric view mode and/or a process centric view mode.

11. The computer program product of claim 9 wherein the action mode enables an activity centric view of context specific activities and/or ad hoc activities to be performed in the context.

12. The computer program product of claim 11 wherein the activity centric view provides a simple activity or a composite activity.

13. The computer program product of claim 12 wherein the composite activity is a guided action in which a sequence of screens is activated each for performing a part of the complex activity.

14. The computer program product of claim 8 wherein the interface is generated from the information architecture using meta data that model the business context.
